(19) United States
(12) Patent Application Publication
(10) Pub. No.: US 2006/0022040 A1
(43) Pub. Date: Feb. 2, 2006

(54) Card connector device

(75) Inventor: Shu Obara, Tokyo (JP)

Correspondence Address: TAKEUCHI & KUBOTERA, LLP, Suite 202, 200 Daingerfield Road, Alexandria, VA, 22314, US

(73) Assignee: HIROSE ELECTRIC CO., LTD.

(21) Appl. No.: 11/185,835

(22) Filed: Jul. 21, 2005

(30) Foreign Application Priority Data
Jul. 29, 2004 (JP) 2004-221927

(51) Int. Cl. G06K 7/06

(52) U.S. Cl. 235/441

(57) ABSTRACT

A card connector device includes a case having a receptacle space for receiving a card and an opening for inserting the card therethrough; a connector disposed at an end portion of the receptacle space in a direction that the card is inserted for connecting the card; a shutter member arranged to be rotatable around a shaft along a width direction of the opening for opening and closing the opening; an urging member for urging the shutter member toward a stopper defining a closed position or from the closed position to an open position; and a guide member for guiding a card having a width smaller than that of the opening, so that the card with a small width can be inserted into the receptacle space at a specific position in addition to a card having a width same as that of the opening.

### BACKGROUND OF THE INVENTION

The present invention relates to a card connector device, especially a card connector device having a shutter member capable of opening and closing an opening of the card connector device for inserting a card.

Japanese Patent Publication No. 09-266028 has disclosed a card electrical connector device with a shutter member. The card electrical connector device includes a main body having a receptacle space for retaining a card as a housing and a connector arranged at an end portion of the receptacle space. When a card is inserted through an opening of the housing, a front edge portion of the card is connected to the connector. Further, the card electrical connector device includes a shutter member at the opening of the housing fro preventing dust and the like from entering the receptacle space.

The shutter member is attached to an upper edge portion of the opening to be rotatable around a shaft arranged along the upper edge. A coil spring is disposed on the shaft for urging the shutter member in a closing direction. When a card is inserted into the housing, a front edge portion of the card pushes the shutter member to rotate in an opening direction, so that the card can be inserted.
Patent Reference 1: Japanese Patent Publication No. 09-266028

Recently, different cards have been available to be selectively inserted into a receptacle space of a same connector device. Such different cards have a same front edge portion to be connected to a connector, and portions behind the front edge portions have different widths. When the shutter member disclosed in Patent Reference 1 is attached to such a connector device, the shutter member needs to have a width same as that of an opening capable of receiving a card with a large width. When a card with a small width is inserted, the shutter member opens over the whole width. Accordingly, it is difficult to regulate the card with a small width at a specific position in a width direction, thereby inserting the card in an inclined state and causing a problem.

### SUMMARY OF THE INVENTION

In view of the problems described above, an object of the present invention is to provide a card electrical connector device capable of adopting a card with a small width. In the invention, it is possible to properly guide and set a card with a small width at a specific position upon inserting.

Further objects and advantages of the invention will be apparent from the following description of the invention.

In order to attain the objects described above, according to the present invention, a card connector device includes a case having a receptacle space for receiving a card and an opening for inserting the card therethrough; a connector disposed at an end portion of the receptacle space in a direction that the card is inserted for connecting the card; a shutter member arranged to be rotatable around a shaft along a width direction of the opening for opening and closing the opening; and an urging member for urging the shutter member toward a stopper defining a closed position or from the closed position to an open position. When the card is inserted into the receptacle space, a front edge portion of the card pushes the shutter member to rotate the shutter member in an opening direction against an urging force of the urging member.

According to the present invention, the card connector device further includes a guide member for guiding the card, so that a card having a width smaller than that of the opening can be inserted into the receptacle space at a specific position in addition to a card having a width same as that of the opening.

With the configuration described above, when a card having a width same as that of the opening is inserted into the receptacle space, similar to a regular connector device with a shutter member, a front edge portion of the card pushes the shutter member over the whole width, and the card is guided with the case in the width direction. When a card having a width smaller than that of the opening is inserted into the receptacle space, the guide member guides the card in the width direction. In this case, the guide member regulates the card not to deviate from a proper direction with or without contacting the card.

In the present invention, the case includes the receptacle space. The case may includes a rear portion with the opening having a width same as that of the card with a large width; a front portion with the connector having a width same as that of the card with a small width; and a transition step portion arranged between the rear portion and the front portion.

According to a first aspect of the present invention, the guide member may be formed of an end edge of a recess portion formed in a surface of the shutter member abutting against the card and recessed in a step shape having a width same as that of the card with a small width. The front edge portion of the card with a small width abuts against a surface of the recess portion to rotate the shutter member in the opening direction. In the process of inserting the card, the end edge of the recess portion guides and regulates the card in the width direction.

According to a second aspect of the present invention, the guide member may be formed of at least one end edge of a cut portion in the width direction formed in the shutter member and having a width same as that of the card with a small width. When the card with a small width is inserted into the receptacle space, the card passes through the cut portion while a side of the card is guided with an edge of the shutter member in the width direction. At this time, the card is guided with at least one end edge of the cut portion in the width direction.

When no card is inserted into the receptacle space, the cut portion remains open. Accordingly, a sub-shutter member may be disposed in the cut portion capable of receiving the card with a small width for preventing dust from entering. When the card is inserted into the receptacle space, the sub-shutter member rotates in an opening direction. The sub-shutter member may be urged in the opening direction, or may not be urged in the opening direction. When the sub-shutter member is not urged in the opening direction, the sub-shutter member hangs downwardly with own weight to a closed position. In this case, the sub-shutter member is just a part of the shutter member, so that it is possible to push the shutter member with a small force to insert the card.

According to a third aspect of the present invention, the guide member is formed of a guide projection formed on the surface of the shutter member abutting against the card. The card with a small width is guided and regulated with the guide projection.

According to a fourth aspect of the present invention, the shutter member includes a first shutter member and a second shutter member divided at a position corresponding to a width of the card with a small width. The first and second shutter members are arranged and urged to separately rotate around shafts on a same line. When the card with a small width is inserted into the receptacle space, only the first shutter member rotates in an opening direction, and the card is guided and regulated with an edge portion of the second shutter member situated at a closed position. Since the second shutter member is situated at a closed position, there is no open portion, thereby effectively preventing dust from entering.

In the present invention, the shutter member is attached to the opening of the case having the receptacle space for inserting the card. Alternatively, the shutter member may be attached to an opening formed in a panel of a device situated near the opening of the case for inserting the card. When the shutter member is attached to the opening of the case, the shutter member is supported on both end portions thereof in a direction of rotational axis with a supporting member formed of metal. The supporting member includes an attaching portion, so that the shutter member is attached to an edge portion of the opening of the case with the attaching portion.

As described above, in the present invention, the card connector device is capable of receiving the card with a small width. When the card with a small width is inserted into the connector device, the shutter member guides the card while maintaining a proper position of the card in the width direction. Accordingly, it is possible to smoothly insert the card without shifting the card in the width direction or inserting the card in an inclined state.

### BRIEF DESCRIPTION OF THE DRAWINGS

FIG. 1 is an exploded perspective view showing a card connector device according to a first embodiment of the present invention;

FIG. 2 is a sectional view showing a shutter member of the card connector device shown in FIG. 1 in use;

FIG. 3 is a plan view showing the shutter member of the card connector device shown in FIG. 1 in use;

FIG. 4 is a perspective view showing a shutter member according to a second embodiment of the present invention;

FIG. 5 is a perspective view showing a modified example of the shutter member according to the second embodiment of the present invention;

FIG. 6 is a perspective view showing a shutter member according to a third embodiment of the present invention;

FIG. 7 is a perspective view showing a shutter member according to a fourth embodiment of the present invention; and

FIG. 8 is a perspective view showing a shutter member according to a fifth embodiment of the present invention.

### DETAILED DESCRIPTION OF THE PREFERRED EMBODIMENTS

Hereunder, embodiments of the present invention will be explained with reference to the accompanying drawings.

### First Embodiment

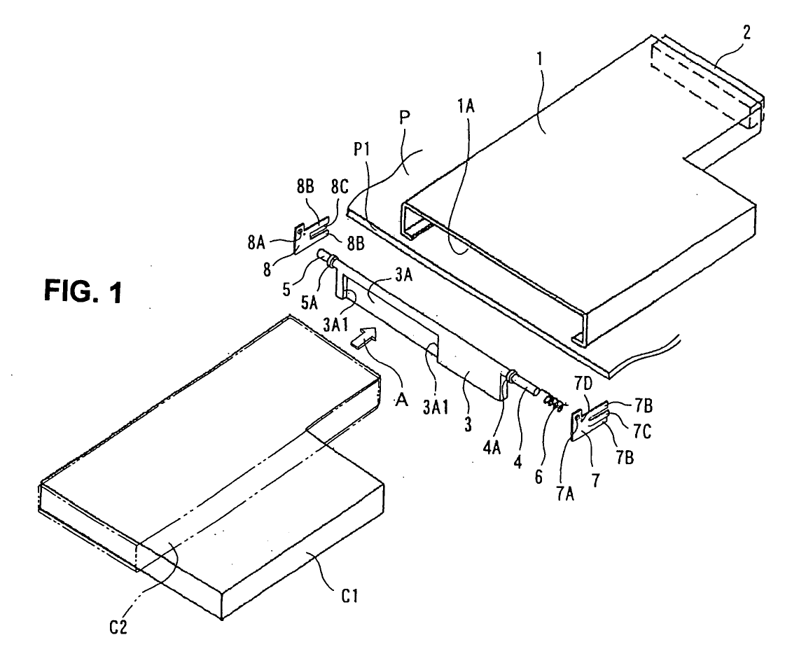

As shown in FIG. 1, a case 1 is attached to a circuit board P of an electrical device, and a connector 2 is disposed at a back of the case 1. The connector 2 has a terminal with a connection portion (not shown) electrically connected to a corresponding circuit on the circuit board P. The terminal of the connector is arranged such that a contact portion of the terminal is connected to a card C1 or a card C2 in the case 1.

Two types of cards C1 and C2, so-called cards with different shapes, are inserted in the case 1 in an arrow direction A. One type of card C1 has a large or wide width indicated by a solid line, and the other type of card has a small or narrow width indicated by a hidden line. The one type of card C1 has a step portion at a middle thereof in a direction that the card is inserted into the case 1, and has a rear end portion with a wide width and a front end portion with a narrow width in the arrow direction A. The front end portion has a width same as that of the connector 2, and is provided with a contact portion to be connected to the connector 2. The other type of card C2 has a uniform width in a rear-to-front direction, and the width is same as that of the front end portion of the one type of card C1. The card C2 is also provided with a contact portion to be connected to the connector 2 at a front end portion thereof.

The case 1 has a receptacle space inside thereof having a shape and a size corresponding to the one type of card C1. The case 1 has an opening 1A at a position corresponding an edge portion P1 of the circuit board P in a rear-to-front direction.

A shutter member 3 is attached to the opening 1A of the case 1. The shutter member 3 is formed in a plate shape having a size slightly larger than the opening 1A of the case 1. When the shutter member 3 is located at an open position, the shutter member 3 is situated slightly away from the opening 1A not to interfere with the opening 1A of the case 1.

The shutter member 3 has shaft portions 4 and 5 at two end portions thereof in a width direction arranged on a same axis line. The shaft portions 4 and 5 have flange portions 4A and 5A, and a coil spring 6 is disposed in the shaft portion 4 to abut against the flange portion 4A. The shaft portions 4 and 5 are provided with support members 7 and 8. The support members 7 and 8 are formed of metal plates having left-to-right symmetrical shapes relative to the axis line, and may have a same shape.

The support members 7 and 8 have support holes 7A and 8A for inserting the shaft portions 4 and 5. The support members 7 and 8 also have first finger portions 7B and 8B and second finger portions 7C and 8C extending forward in parallel to each other and arranged at upper and lower positions. The second finger portions 7C and 8C have bent portions at base portions thereof to form spaces in a plate thickness direction relative to the first finger portions 7B and 8B. The spaces have a size slightly smaller than a plate thickness of the case 1.

When the shutter member 3 is attached to the case 1, after the coil spring 6 and the support member 7 are attached to the shaft portion 4, and the support member 8 is directly attached to the shaft portion 5, the first finger portions 7B and 8B and the second finger portions 7C and 8C sandwich sidewalls of the case 1 at the opening 1A in the plate thickness direction to attach the support members 7 and 8 to the case 1. The coil spring 6 has one end portion engaging the flange portion 4A of the shutter member 3 and the other end portion engaging a hole 7D of the support member 7. The coil spring 6 urges the shutter member 3 to rotate in a closing direction with an urging force thereof.

When the shutter member 3 is situated at a close position, the coil spring 6 becomes a natural shape thereof. Alternatively, the coil spring 6 urges the shutter member 3 beyond the close position, and the shutter member 3 abuts against a stopper formed on the case 1 (for example, a panel of a housing) at the close position.

The shutter member 3 is provided with a recess portion 3A in a surface thereof abutting against the front end portion of the card C2 when the card 2 is inserted into the case 1. The recess portion 3A has a size corresponding to the front end portion of the card C2 and an arbitrary depth. The recess portion 3A has the depth increasing toward a free end portion of the shutter member 3, so that the card C2 is guided with a sufficient depth. When the card C2 has a step portion in an upper surface thereof in a width direction, the recess portion 3A may have a shape corresponding to the step portion.

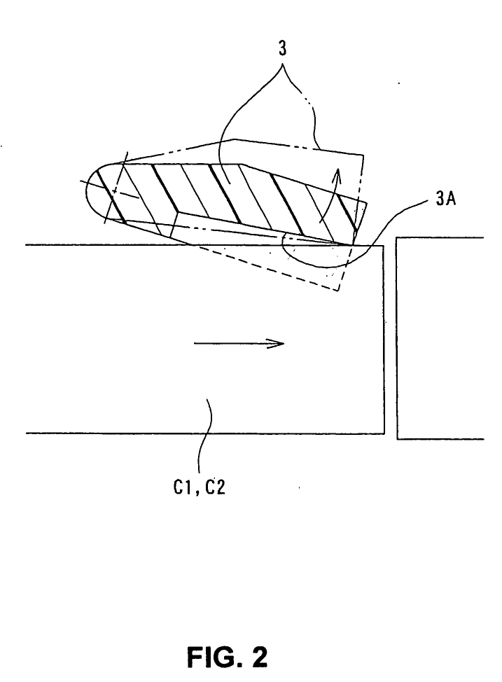

When the two types of cards are inserted into the connector device with the shutter member provided at the opening, the cards are guided as follows. In a case of the card C1 with a wide width, first, the front end portion of the card C1 abuts against the recess portion 3A of the shutter member 3. Accordingly, as indicated by a solid line in FIG. 2, the card C1 is inserted into the case 1 while lifting the shutter member 3 in the opening direction. At this time, the card C1 has the front portion with a narrow width, and is guided with at lease one edge portion 3A1 of the recess portion 3A in the width direction, thereby preventing the card C1 from shifting in the width direction.

As the card C1 is inserted further, the rear portion of the card C1 with a wide width lifts the shutter member 3 in a state indicated by a phantom line in FIG. 2. The card C1 is guided with an inner surface of the case 1, and is connected to the connector 2 at a specific position. When the card C1 is pulled out from the case 1, in a reversed process, the rear portion with a wide width is guided with the case, and then the front portion with a narrow width is guided with the one edge portion 3A1 of the recess portion 3A.

In a case of the card C2 with a narrow width, the card C2 is not guided with the case 1 to regulate a position thereof in the width direction. The front end portion of the card C2 abuts against the recess portion 3A of the shutter member 3. Accordingly, as indicated by the solid line in FIG. 2, the card C2 is inserted into the case 1 while lifting the shutter member 3 in the opening direction, similar to the case of the card C1. A rear portion of the card C2 has a width same as that of the front portion of the card C2. Accordingly, the card C2 is guided with the recess portion 3A, i.e., the one edge portion 3A1 of the recess portion 3A, all the way through the case 1 to regulate a position thereof in the width direction. When the card C2 is pulled out from the case 1, the card C2 is guided with the one edge portion 3A1 all the way through the case 1 to regulate a position thereof in the width direction.

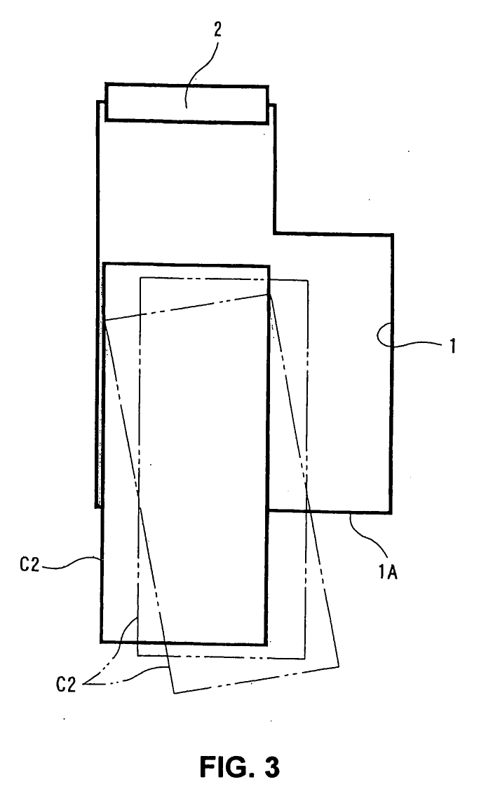

As described above, in the connector device according to the first embodiment, the two types of cards are guided while maintaining a specific position in the width direction upon inserting into the case. Accordingly, the card C2 is not shifted or inclined relative to a specific position indicated by a solid line in FIG. 3 upon inserting into the case 1 and pulling out from the case 1. In the embodiment, the card C2 is guided all the way through the case 1, and it is sufficient to guide the card C2 when both sides of the card C2 are not guided with the case 1.

### Second Embodiment

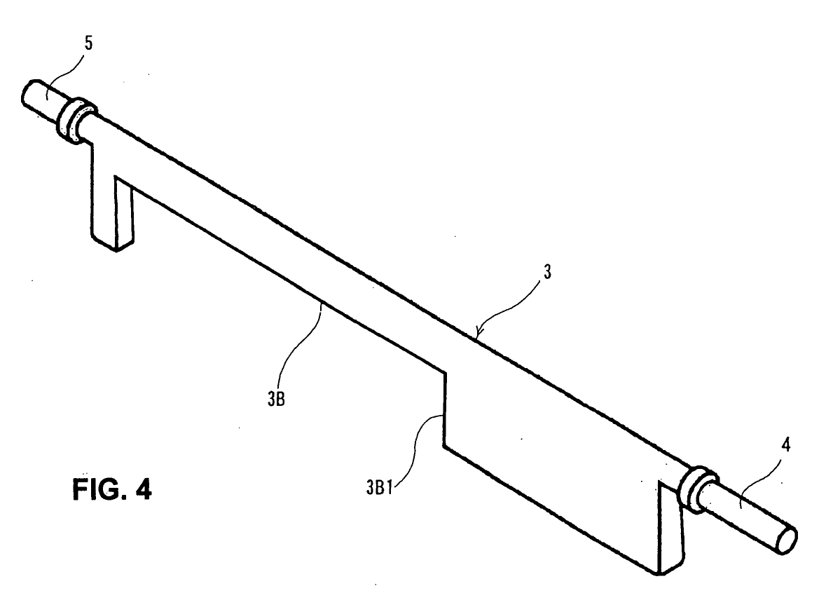

FIG. 4 is a perspective view showing a shutter member 3 according to a second embodiment of the present invention. The shutter member 3 is provided with a cut portion 3B at a position corresponding to the recess portion of the shutter member in the first embodiment. In the second embodiment, in a case of the card C2, when the card C2 is inserted into the case 1, the shutter member 3 does not rotate and stays at the closed position. The card C2 passes through the cut portion 3B while being guided with an edge portion 3B1 to regulate a position thereof in the width direction.

When the card C1 with a wide width is inserted into the case 1, similar to the first embodiment, the shutter member 3 rotates in the opening direction. When the cut portion has a height slightly smaller than that of the card, it is possible to rotate the shutter member when the card is inserted into the case.

In the embodiment, it is sufficient that the cut portion 3B has one edge portion in the width direction. Accordingly, the other end, a left side in FIG. 4, may be open.

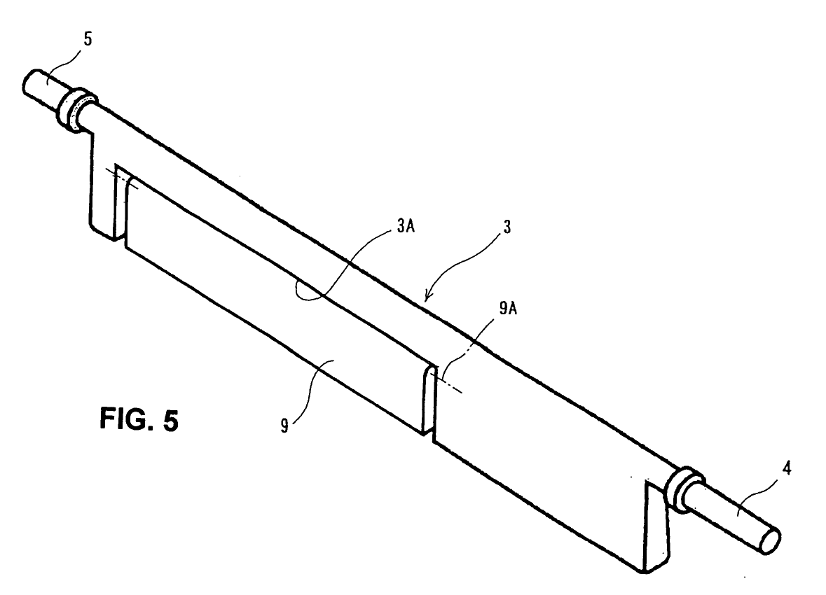

FIG. 5 is a perspective view showing a modified example of the shutter member according to the second embodiment of the present invention. As shown in FIG. 5, a sub-shutter member 9 is disposed in the cut portion 3B to hang downwardly and freely rotate around an axis line 9A at an upper edge thereof. When the card C2 passes through, the front end portion of the card C2 pushes and lifts the sub-shutter member 9. In the modified example, the shutter member does not remain open when the card is not used, thereby preventing dust from entering.

### Third Embodiment

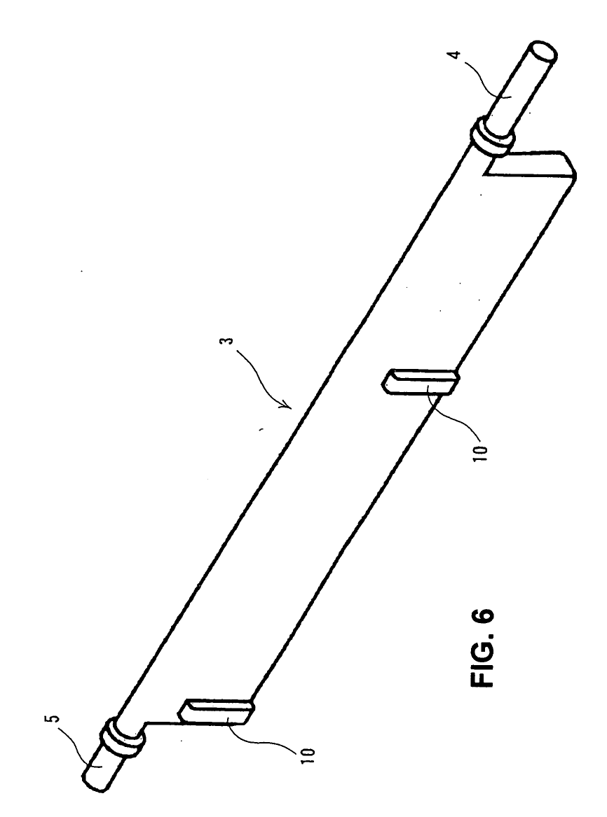

FIG. 6 is a perspective view showing a shutter member 3 according to a third embodiment of the present invention. The shutter member 3 is provided with guide projections 10 on a surface thereof abutting against the front end portion of the card upon inserting into the case. In the third embodiment, the card is guided between the guide projections 10 while lifting the shutter member 3 to rotate upwardly. In order to securely guide the card, it may be necessary to provide a guide member having a large area for regulating a side of the card. When the guide projections of the third embodiment are provided together with the cut portion of the second embodiment, it is possible to increase such an area for regulating the card.

### Fourth Embodiment

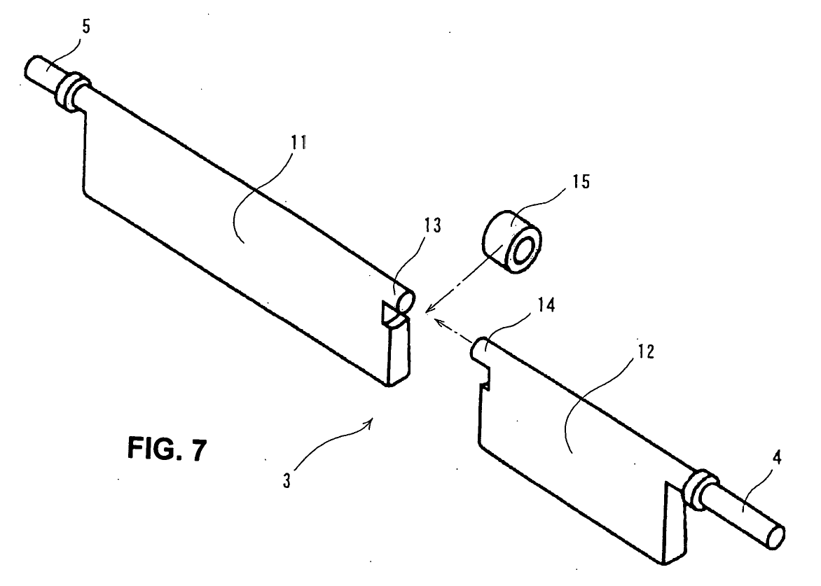

FIG. 7 is a perspective view showing a shutter member according to a fourth embodiment of the present invention. As shown in FIG. 7, the shutter member 3 is divided into a first shutter member 11 and a second shutter member 12. The first shutter member 11 has a width corresponding to a width of the card having a narrow width. A total width of the first shutter member 11 and the second shutter member 12 corresponds to a width of the card having a wide width. The first and second shutter members 11 and 12 have short shaft portions 13 and 14 at a connecting portion thereof aligned with an axial line of the shaft portions 4 and 5. The short shaft portions 13 and 14 are fitted into a collar 15, and each of the shaft portions 4 and 5 is provided with a coil spring. Accordingly, the first and second shutter members 11 and 12 constitute the shutter member 3, and rotate independently.

In the fourth embodiment, in a case of the card with a narrow width, only the first shutter member 11 opens, and the card is guided with an edge portion of the second shutter member 12 in the width direction. In a case of the card with a wide width, the first and second shutter members 11 and 12 open together. The first shutter member may be omitted, and only the second shutter member may be provided. In this case, it is possible to aim the card at an opening corresponding to the first shutter member upon inserting.

### Fifth Embodiment

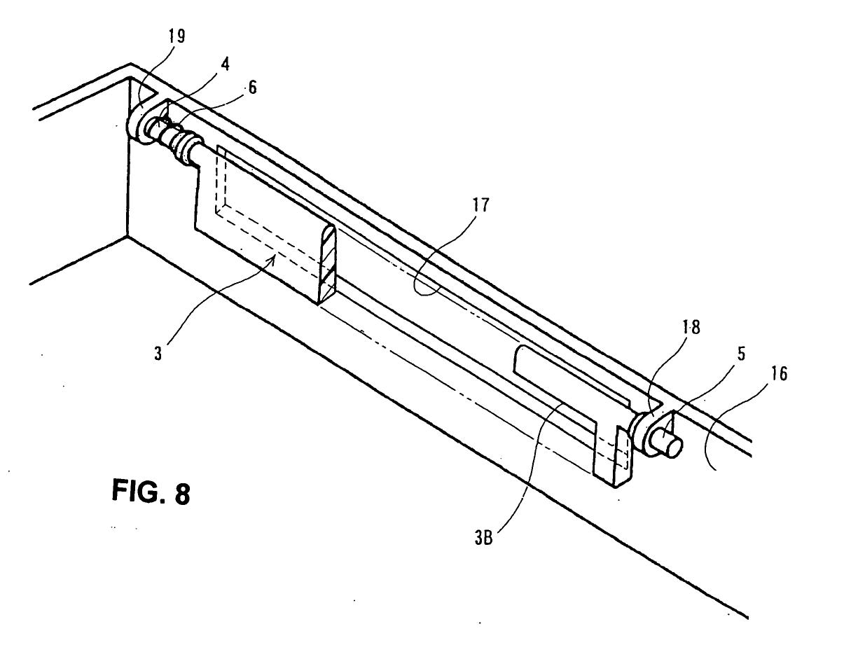

In the embodiments described above, the shutter member is provided at the opening of the case for inserting the card. In a fifth embodiment, a shutter member is provided at a front panel 16 of a housing of a device arranged adjacent to the opening of the case. FIG. 8 is a perspective view showing a shutter member 3 according to the fifth embodiment of the present invention. The shutter member 3 is the same as that shown in FIG. 4, and is viewed from a rear side thereof.

As shown in FIG. 8, the front panel 16 of the housing is provided with a window 17 for inserting the card. The shutter member 3 is supported on a backside surface of the window 17 with the shaft portions 4 and 5, similar to that shown in FIG. 1. Different from that shown in FIG. 1, the shaft portions 4 and 5 are supported with support portions 18 and 19 formed on the front panel 16. In the fifth embodiment, the shutter member 3 shown in FIG. 4 is provided, and those of the embodiments described above may be provided instead.

In the invention, further modifications may be possible. For example, the receptacle space for retaining the card may be a space for stacking the card therein. That is, the receptacle space may be formed in two stages for retaining two cards, and each of the stages may be provided with the shutter member. Depending on a configuration of a device, two cards may be combined with a front side and a backside up side down, and the receptacle space may be formed in an up side down configuration accordingly.

The disclosure of Japanese Patent Application No. 2004-221947, filed on Jul. 29, 2004, is incorporated in the application.

While the invention has been explained with reference to the specific embodiments of the invention, the explanation is illustrative and the invention is limited only by the appended claims.

What is claimed is:

1. A card connection device for receiving and connecting a first card having a first width and a second card having a second width smaller than the first width, comprising:
a case having an opening and a receptacle space, said opening having an opening width equal to or slightly larger than the first width;
a connector disposed in the case to be connected to the first card or the second card;
a shutter member disposed adjacent to the opening to be freely rotatable around an axis line extending in a width direction for opening and closing the opening;
an urging device for urging the shutter member toward a closed position; and
a guide member for guiding the second card to regulate a position of the second card in the width direction.

2. The card connection device according to claim 1, wherein said case includes a rear portion having a width equal to or lightly larger than the first width, a front portion having a width equal to or lightly larger than the second width, and a transition step portion arranged between the rear portion and the front portion, said opening being disposed in the rear portion, said connector being disposed in the front portion.

3. The card connection device according to claim 1, wherein said guide member includes an end edge of a recess portion formed in a surface of the shutter member abutting against the first card or the second card, said recess portion being recessed in a step shape having a width equal to or lightly larger than the second width.

4. The card connection device according to claim 1, wherein said guide member includes at least one end edge of a cut portion in the width direction formed in the shutter member, said cut portion having a width equal to or lightly larger than the second width.

5. The card connection device according to claim 4, further comprising a sub-shutter member disposed in the cut portion capable of passing the second card therethrough.

6. The card connection device according to claim 1, wherein said guide member includes a guide projection formed on a surface of the shutter member abutting against the first card or the second card for guiding the second card.

7. The card connection device according to claim 1, wherein said shutter member includes a first shutter member having a width equal to or lightly larger than the second width and a second shutter member, said first and second shutter members being arranged and urged to separately rotate around a same axial line.

8. The card connection device according to claim 1, wherein said shutter member is attached to the opening.

9. The card connection device according to claim 1, wherein said shutter member is attached to a panel opening formed in a panel of a device situated adjacent to the opening.

10. The card connection device according to claim 1, further comprising a support member for supporting the shutter member to rotate around the axis line, said support member including an attaching member attached to an edge portion of the opening.
